(19) United States
(12) Patent Application Publication
(10) Pub. No.: US 2009/0113377 A1
(43) Pub. Date: Apr. 30, 2009

(54) SYSTEM AND METHOD FOR BUILDING A BACKEND TOOL CONNECTOR IN SUPPORT OF HETEROGENEOUS DATA SOURCES

(76) Inventors: Michael Cacenco, Brampton (CA); David DeBruin, Guelph (CA); Daniel Mateescu, Woodbridge (CA)

Correspondence Address: GOWLING LAFLEUR HENDERSON, LLP, Suite 2600, 160 Elgin Street, Ottawa, ON, K1P 1C3, CA

(21) Appl. No.: 11/926,979

(22) Filed: Oct. 29, 2007

(51) Int. Cl. G06F 9/44

(52) U.S. Cl. 717/100

(57) ABSTRACT

A plug-in is provided for use with an authoring program. The plug-in facilitates developing an application for communicating with heterogeneous data sources. The plug-in comprises a plug-in interface for interfacing with the authoring application, logic for determining the functionality exposed by the data source described by the generic schema, and a service descriptor generator for generating a service descriptor of the data source. The generated service descriptor is described using a schema common to the authoring application.

### TECHNICAL FIELD

This disclosure relates generally to application development environments and in particular to a system and method for connecting to heterogeneous data sources.

### BACKGROUND

Due to the proliferation of wireless networks, there are a continually increasing number of wireless devices in use today. These devices include mobile telephones, personal digital assistants (PDAs) with wireless connectivity, two-way pagers and the like.

With the increasing use of wireless devices, the demand for additional applications has also increased. For example, in addition to providing access to email, wireless devices may also provide applications that access various data sources such as music downloading services, weather reports, stock information, etc.

Creating applications for wireless devices can present various difficulties to application developers. For example, the devices typically have limited processing power and limited storage and/or memory available. Furthermore, with the proliferation of the various wireless devices, it may be difficult to generate applications that will run on more than one device or type of device. Wireless application development may be facilitated through the use of an integrated design environment (IDE). An IDE may provide a visual method for designing an application.

Wireless applications may connect to a web service that provide information to the wireless application. The web services are described using web service description language (WSDL) which describes the contract (or interface) provided by the web service that can be used when accessing the service. Web services defined by WSDL are increasingly used as a way to allow various systems to communicate and exchange information.

An IDE may provide functionality for generating an application definition based on a WSDL document. This functionality may be used to quickly create wireless applications that receive information from the web service. However, in order to generate the application definitions from the WSDL description the IDE must have knowledge of the WSDL language and how to generate the application definition (i.e. the application components and how they are cross-connected) from the WSDL document.

While there is a proliferation of web services described using WSDL, it is desirable to be able to create applications that can communicate with a data source that is not described in WSDL. For example, a database may provide remote access, however the contract (or interface) used for accessing the information may not be described in a WSDL. It is difficult to provide an IDE with the functionality of generating an ad-hoc application definition from a data source (i.e. a web service, database, proprietary service etc.) that are not described using WSDL.

It is desirable to have an IDE that may be extended to add functionality for generating an application definition from a data source that is not described using WSDL.

### BRIEF DESCRIPTION OF THE DRAWINGS

An embodiment of the present disclosure will now be described by way of example with reference to the following drawings in which:

FIG. 1 depicts in a block diagram, a prior-art integrated design environment;

FIG. 2 depicts in a block diagram, an IDE and plug-in in accordance with the present disclosure;

FIG. 3 depicts in a block diagram an IDE and plug-in in accordance with the disclosure; and

FIG. 4 shows in a flow chart a method of using an IDE to create an application definition in accordance with the disclosure.

### SUMMARY

In accordance with the present disclosure, there is provided a plug-in for use with an authoring application for facilitating development of a wireless application. The wireless application is for communicating with a data source described by a generic schema. The plug-in comprises a plug-in interface for interfacing with the authoring application, the plug-in interface is defined by the authoring program. The plug-in further comprises logic for determining the functionality exposed by the data source described by the generic schema, and a service descriptor generator for generating a service descriptor of the data source, the generated service descriptor being described using a schema common to the authoring application.

In accordance with the present disclosure, there is further provided a method for using a plug-in with an authoring application for facilitating development of a wireless application. The wireless application is for communication with a data source described by a generic schema. The method comprises providing a plug-in interface for interfacing with the authoring application, the plug-in interface defined by the authoring program. The method further comprises determining the functionality exposed by the data source described by the generic schema, and generating a service descriptor of the data source, the generated service descriptor being described using a schema common to the authoring application.

In accordance with the present disclosure, there is further provided a computer-readable medium storing instructions or statements for use in the execution in a computer of a method of using a plug-in with an authoring application for facilitating development of a wireless application, the wireless application for communication with a data source described by a generic schema. The method comprises providing a plug-in interface for interfacing with the authoring application, the plug-in interface defined by the authoring program. The method further comprises determining the functionality exposed by the data source described by the generic schema, and generating a service descriptor of the data source, the generated service descriptor being described using a schema common to the authoring application.

In accordance with the present disclosure, there is also provided a propagated signal carrier carrying signals containing computer-executable instructions that can be read and executed by a computer, the computer-executable instructions being used to execute a method of using a plug-in with an authoring application for facilitating development of a wireless application, the wireless application for communication with a data source described by a generic schema. The method comprises providing a plug-in interface for interfacing with the authoring application, the plug-in interface defined by the authoring program. The method further comprises determining the functionality exposed by the data source described by the generic schema, and generating a service descriptor of the data source, the generated service descriptor being described using a schema common to the authoring application.

### DETAILED DESCRIPTION

FIG. 1 depicts in a block diagram, an example of an integrated design environment (IDE) 105. The IDE 105 can be used by developers to create applications. The IDE 105 has functionality 110 for generating a component application definition 115 from a web service 120 described by a web service description language (WSDL) document 122. The functionality 110 reads the WSDL definition and generates the application definition. The functionality 110 is able convert WSDL elements to the application component definitions and the cross-connection of the components.

In order to create an application for connecting to a web service that is not defined by a WSDL document, the developer must define the component definitions. In order to provide an IDE with the functionality to generate the application definition from the data schema, it would be necessary to add the functionality to the IDE, that is, essentially provide the developer with a new version of the IDE with the functionality built in.

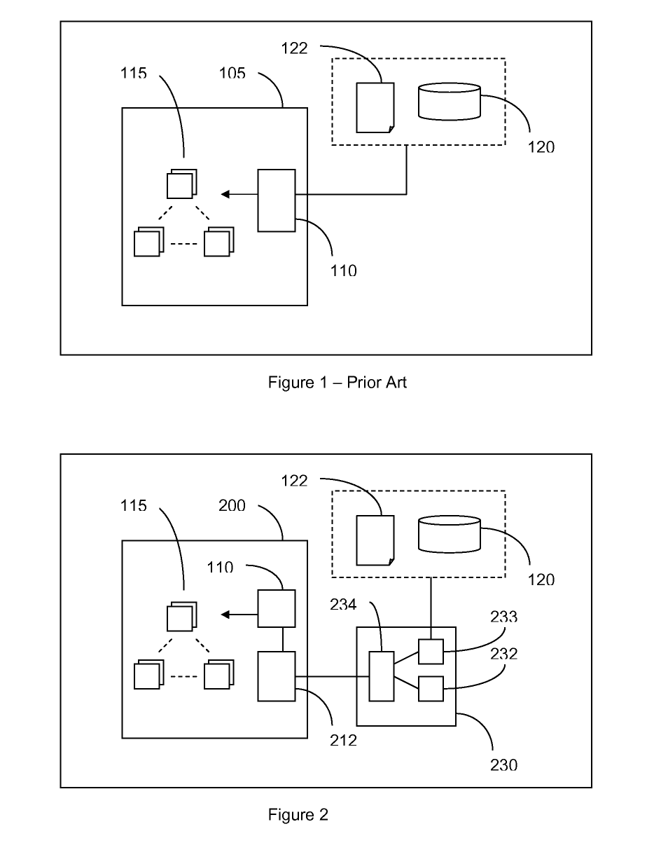

FIG. 2 depicts in a block diagram, an example of an authoring application 200 and plug-in 230, in accordance with an embodiment of the present disclosure. The authoring application 200 is described herein as an IDE 200. However it is understood that the authoring application 200 may include, for example, a rapid application development (RAD) tool, a text editor, etc. The IDE 200 has functionality (referred to as an application definition generator) 110 for generating an application definition from a known definition language type, for example WSDL. This known definition language will be referred to as the IDE description language for clarity. The IDE description language is described herein as being WSDL, however one skilled in the art will recognize that an IDE could be designed to use a different language as the IDE description language.

The IDE 200 may create an application as a definition of data components, message components and screen components. The component definitions 115 may be written in extensible markup language (XML) and so be common to a large number of platforms, or devices. When defining an application as a set of components, the data may represent application information, such as for example, the price of a stock. Screen components may describe how to display the information on particular devices and message components may describe how data is transferred between a server and the wireless device. For example, when creating a component application, the visual IDE may allow a developer to create the screen components using a drag and drop approach (for example, creating a label, button, text box etc.). The IDE may allow the developer to define the data components and the message components, as well as how each component is interconnected to another. The IDE is used to generate an application definition that may be uploaded into an application repository and registry. The application may then be provisioned on a wireless device, such as for example, a smartphone.

The IDE 200 further has functionality (referred to as a plug-in receptacle) 212 for connecting to a plug-in 230. The plug-in 230 and the plug-in receptacle 212 (also referred to as an extension-point) implement a plug-in interface. The plug-in interface may be provided through a lightweight software componentry framework. The plug-in interface describes how the plug-in 230 and plug-in receptacle 212 can communicate with each other. The plug-in interface may be described as an API, in an XML document, or other appropriate means. The plug-in receptacle 212 allows the use of the plug-in 230 to generate a description of the data source in the IDE 200 description language. The IDE description language is common to both the plug-in 230 and the IDE 200, and allows the plug-in 230 to generate a description that can be understood by the IDE 200. The IDE 200 may then use the generated IDE description language description of the data source to create an application definition for an application that is able to access the data source 120.

The IDE 200 may provide an extension point, for example named ‘backends’, which constitutes the backbone of the receptacle 212 for various custom data source plug-ins 230. An example of a plug-in receptacle 230 manifest is described below.

```
<plugin
    id=”net.rim.wica.tools.studio.datasource.connector”
    name=”Connector Plug-in”
    version=”1.0.0”
    provider-name=”RIM”
    class=”net.rim.wica.tools.studio.datasource.connector.-
ConnectorPlugin”>
    <runtime>
      <library name=”dsconnector.jar”>
          <export name=”*”/>
      </library>
    </runtime>
    <requires>
      <import plugin=”org.eclipse.core.runtime.compatibility”/>
      <import plugin=”org.xmlsoap.schemas.wsdl” export=”true”/>
    </requires>
    <extension-point
      id=”backends” name=”backends”
schema=”schema/backends.exsd”/>
</plugin>
```

The above example describes the general plug-in receptacle 212 provided by the IDE 200. The IDE 200 may provide an extension point where the custom plug-ins 230 can be hooked. An example of an extension point schema definition is provided below for use when creating a plug-in 230 to hook with the extension point.

```
<schema
    targetNamespace=”net.rim.wica.tools.studio.datasource.connector”>
    <annotation>
      <appInfo>
          <meta.schema
            plugin=”net.rim.wica.tools.studio.datasource.connector
            id=”backends”
            name=”backends”/>
      </appInfo>
      <documentation>
          Backend extension point to hook heterogeneous data source
connectors
      </documentation>
    </annotation>
    <element name=”extension”>
      <complexType>
          <sequence>
            <element ref=”backend” minOccurs=”0”
maxOccurs=”10”/>
          </sequence>
          <attribute name=”point” type=”string” use=”required”>
            <annotation>
                <documentation>
                </documentation>
            </annotation>
          </attribute>
          <attribute name=”id” type=”string”>
            <annotation>
                <documentation>
                </documentation>
            </annotation>
          </attribute>
          <attribute name=”name” type=”string”>
            <annotation>
                <documentation>
                </documentation>
            </annotation>
          </attribute>
      </complexType>
    </element>
    <element name=”backend”>
      <complexType>
          <attribute name=”id” type=”string”>
            <annotation>
                <documentation>
                </documentation>
            </annotation>
          </attribute>
          <attribute name=”description” type=”string” use=”required”>
            <annotation>
                <documentation>
                </documentation>
            </annotation>
          </attribute>
          <attribute name=”class” type=”string”>
            <annotation>
                <documentation>
                </documentation>
                <appInfo>
                  <meta.attribute kind=”java”
    basedOn=”net.rim.wica.tools.studio.datasources.connector.-
    Iconnector”/>
                </appInfo>
            </annotation>
          </attribute>
          <attribute name=”backendType”>
            <annotation>
                <documentation>
                </documentation>
            </annotation>
          </attribute>
      </complexType>
    </element>
    <annotation>
      <appInfo>
          <meta.section type=”since”/>
      </appInfo>
      <documentation>
          [enter the first release in which this extension point appears]
      </documentation>
    </annotation>
    <annotation>
      <appInfo>
          <meta.section type=”examples”/>
      </appInfo>
      <documentation>
          [enter extension point usage example]
      </documentation>
    </annotation>
    <annotation>
      <appInfo>
          <meta.section type=”apiInfo”/>
      </appInfo>
      <documentation>
          [enter API information]
      </documentation>
    </annotation>
    <annotation>
      <appInfo>
          <meta.section type=”implementation”/>
      </appInfo>
      <documentation>
          [enter information about supplied information of this extension
point]
      </documentation>
    </annotation>
    <annotation>
      <appInfo>
          <meta.section type=”copyright”/>
      </appInfo>
      <documentation>
      </documentation>
    </annotation>
</schema>
```

Using the above schema definition, an example of a custom plug-in interface is provided below. The example plug-in 230 is for accessing database data sources 120.

```
<plugin
    id=”com.my_company.studio.datasource.connector.dbc”
    name=”Dbc Plug-in”
    version=”1.0.0”
    provider-name=”My-Company”
    class=”com.my_company.studio.datasource.connector.dbc.-
DbcPlugin”>
    <runtime>
      <library name=”connector-dbc.jar”>
          <export name=”*”/>
      </library>
    </runtime>
    <requires>
      <import plugin=”org.eclipse.ui”/>
      <import plugin=”org.eclipse.core.runtime”/>
      <import plugin=”net.rim.wica.tools.studio.datasource.connector”/>
    </requires>
    <extension
      point=”net.rim.wica.tools.studio.datasource.connector.backends”>
      <backend backendType=”database”
class=”com.my_company.studio.datasource.connector.dbc.DBConnector”
description=”Database connector plugin” id=database”/>
    </extension>
</plugin>
```

In this example, the custom plug-in 230 described by the above manifest depends on a ‘net.rim.wica.tools.studio.datasource.connector’ receptacle. The custom plug-in 230 describes a DBConnector class for hooking to the ‘backends’ extension point of the IDE 200.

The DBConnector implements the functionality required to communicate with various database data source(s). The DBConnector class provides an abstract class that can be used to provide functionality for connecting to a database that is described by a generic schema. The DBConnector may be used to generate a description of the database for the IDE 200 in the IDE description language common to the plug-in 230 and IDE 200, such as WSDL, or enhanced WSDL. An example of the DBConnector class is described below.

```
Package com.my_company.studio.datasource.connector.dbc;
Import org.xmlsoap.schemas.wsdl.DocumentRoot;
Import net.rim.wica.tools.studio.datasource.connector.IConnector;
Import net.rim.wica.tools.studio.datasource.connector.IconnectorInfo;
Public class DBConnector implements IConnector
{
    private IDBConnectorInfor _connectorInfo =
DbcFactory.eINSTANCE.createIDBConnectorInfo( );
    private static DbcPackage _condbcPackage =
    DbcPackage.eINSTANCE;
    private static org.xmlsoap.schemas.wsdl.-
    WsdlPackage _wsdlPackage =
org.xmlsoap.schemas.wsdl.WsdlPackage.eInstance;
    private DocumentRoot _wsdlRoot;
public DocumentRoot getDocumentRoot(IconnectorInfo connectorInfo)
    throws Exception {
      _connectorInfo = (IDBConnectorInfo) connectorInfo;
      //set the driver for connecting to the datasource(ie JDBC)
      Class.forName(driver);
      //get the connection for the url & credentials
      conn = DriverManager.getConnection(url, loginid, pass);
      //get the databaseMetaData object or other means of interrogating
      //the schema
      DatabaseMetaData dbmd = conn.getMetaData( );
      //get the schema/catalog for the user or database
      //get tables, columns, procedures and procedureColumns for the
      //respective schema or catalog
      //present a dialog to select a sub-schema: stored-procedures can
      //be mapped directly to equivalent operations; SELECT
      //statements on tables can be used to build other input messages
      //and their resultSets to build the corresponding output message.
      //generate WSDL from sub-schema
      return _wsdlRoot;
    }
```

In the main method above, getDocumentRoot, a parameter of type IConnectorInfo is passed when it is called from the IDE 200 through the plug-in receptacle 212. The IConnectorInfo parameter holds the data source URL, credentials (i.e., username and password) and whatever is required to access the schema. From the schema, a description of the data source is generated in the IDE description language as the root document. The IDE description language document has operations that were transformed from entities in the schema. The plug-in class is designed to generate a description of a data source 120 based on the specific schema description 122 of the data source 120.

For a database schema, the meta-data of the database schema is analyzed for stored-procedures, functions and user types. Procedures and user functions can translate into operations. A result set may then be defined as arrays of complexTypes. Ad-hoc operations may be built from tables and views using the Structured Query Language (SQL) language (or other language as used by the data source). Special WSDL bindings can be used to express the underlying SQL statements for the different operations. The SQL statements may be included in an enhanced WSDL description if the enhanced WSDL is understood by both the plug-in 230 and IDE 200.

Before the DBConnector class makes a connection to the database, the connection is first prepared. This is achieved by setting the appropriate driver, url and credentials for the connection. These settings may be passed to the DBConnector using the IConnectorInfo interface. The DBConnector may be configured for choosing the correct driver and other characteristics.

The IConnectorInfo interface may be used to collect the necessary information for establishing a connection to the data source. An example schema of an IConnectorInfo interface that is specialized for establishing a connection to a database data source 120 is provided below.

```
<xsd:schema
    targetNamespace=”http:///net/rim/wica/tools/studio/datasource/
connector/dbConnector.ecore”
    xmlns:net.rim.wica.tools.studio.datasource.connector=”http:///net/rim/
wica/tools/studio/datasource/connector.ecore”
    xmlns:net.rim.wica.tools.studio.datasource.connector.db=”http:///net/
rim/wica/tools/studio/datasource/connector.dbConnector.ecore”
    xmlns:xmi=”http://www.omg.org/XMI”
    xmlns:xsd=”http://www.w3.org/2001/XMLSchema”>
    <xsd:import
    namespace=”http:///net/rim/wica/tools/studio/datasource/
connector.ecore”
    schemaLocatioin=”connector.xsd”/>
    <xsd:import
      namespace=”http://www.omg.org/XMI”
      schemaLocation=”XMI.xsd”/>
    <xsd:complexType name=IDBConnectorInfo”>
      <xsd:complexContent>
          <xsd:extension base =
“net.rim.wica.tools.studio.datasource.connector:IconnectorInfo”>
            <xsd:attribute name=”driver” type=”xsd:string”/>
            <xsd:attribute name=”user” type=”xsd:string”/>
            <xsd:attribute name=”password” type=”xsd:string”/>
            <xsd:attribute name=”driver_id” type=”xsd:string”/>
            <xsd:attribute name=”schema” type=”xsd:string”/>
          </xsd:extension>
      </xsd:complexContent>
    </xsd:complexType>
    </xsd:element name=”IDBConnectorInfo”
type=”net.rim.wica.tools.studio.datasource.-
connector.db:IDBConnectorInfo”/>
</xsd:schema>
```

The functionality of the service descriptor generator 232 may be included in the plug-in 230 (for example, the DBConnector class described above), or it may be implemented separate from the plug-in 230. Regardless of the specific implementation details, the service descriptor generator 232 provides processing of the data source schema 122 into the IDE description language (for example WSDL or enhanced WSDL) and XML schema description (XSD) schema components and vendor specific (specialized) extensions that deal with specifics when exploring the data source schema 122 and generating the IDE description language.

The plug-in 230 implements the plug-in interface 234 in order to facilitate communication with the IDE 200 through the plug-in receptacle 212. The plug-in 230 also provides logic 233 for connecting to a data source 120, and exploring the data source 120. The logic 233 for exploring the data source 120 is designed to communicate with the data source 120. From the data source schema 122, the logic 233 determines the functionality exposed by the data source 120 and how to communicate with the data source 120 in order to use the functionality of the data source 120. The service descriptor generator 232 uses this information when generating the IDE description language description of the data source 120.

A plug-in connector may be generated when a plug-in 230 is created. The generated connector can be included in a gateway server to which a wireless device connects. The wireless device accesses the data source 120 through the gateway, using a wireless application. The generated connector provides a similar function to the application, as the plug-in 230 achieves for the IDE 200. The wireless application connects to the gateway server which uses the connector to convert communications (i.e., in coming and out going messages) from the application into a format expected by the data source 120 (i.e., as described by the data source schema definition), and communications from the data source 120 into the format expected by the wireless application.

A plug-in 230 can be created for creating an IDE description language definition of a data source 120. The plug-in 230 may be created in a design environment such as Eclipse™. Eclipse provides a framework model for creating plug-ins. As described above, the plug-in 234 and plug-in receptacle 212 of the IDE must implement the same interface, such as extension-point.

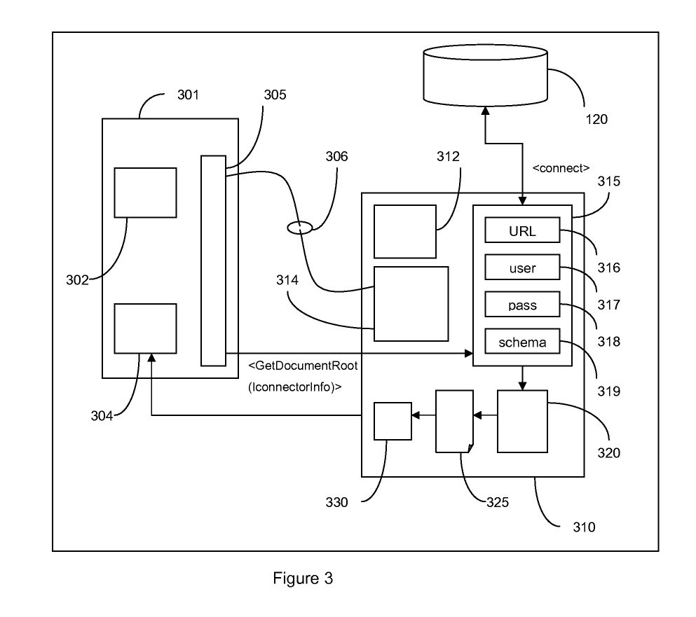

FIG. 3 depicts in a block diagram an example of the communication between an IDE 301, a plug-in 310 and data source 120, in accordance with an embodiment of the present disclosure. The IDE 301 provides an application developer with the ability to create an application definition using a plug-in 310 for connecting to a data source 120. The IDE 301 includes a description language 302 that can be used by the plug-in 310 to describe the data source 120. As described above, the description language may be, for example, WSDL or enhanced WSDL that is able to describe the data source 120. The IDE 301 may also comprise a backend connector wizard 304 that provides functionality for using a desired plug-in 310. The functionality of the wizard 304 may include for example, selecting the desired plug-in 310, allowing for plug-in 310 properties to be set, etc. The IDE 301 also comprises a receptacle 305 of the plug-in interface 306. The receptacle 305 is a backend extension point. The extension point may be based on, or extend a plug-in framework provided by the IDE 301.

The plug-in 310 may extend a plug-in framework. This framework for example could include an abstract plug-in class (represented as 312). The plug-in 310 connects to the plug-in interface 306 implemented by receptacle 305. The corresponding plug-in interface is represented as 314. The interface 306 may be comprise an IConnector structure and an ICnnectorInfo structure. The plug-in side interface 314 may implement a method defined by the interface, such as getDocumentRoot(IConnectorInfo) for calling the logic of the plug-in.

The plug-in 310 comprises a discovery page 315 associated with a particular data source 120. The discovery page 315, may comprise, for example, information received from an IConnectorInfo structure. This information may comprise a uniform resource locator (URL) 316 of the particular data source 120, a username 317 and password 318 for connecting to the particular data source 120. The schema 319 of the discovery page may be obtained from the logic of the plug-in 310 for exploring the functionality exposed by data source 120 using the generic schema type that is used to describe the data source 120.

The plug-in 310 uses the information of the discovery page 315 to connect to the data source 120, when for example getDocumentRoot is called via the plug-in interface 306. The plug-in 310 explores the functionality of the data source 120 and generates an IDE description language description of the data source 120 using a service descriptor generator 320. The IDE description language may be, for example, enhanced WSDL. The enhanced WSDL description may be returned to the IDE 301 via the plug-in interface 306 as an enhanced DocumentRoot, that may have the bindings and services extended. Optionally, the plug-in 310 may provide a selector 330 for selecting a subset of the functionality exposed by the data source 120 to include in the DocumentRoot description.

Using an IDE 200, 301 with an appropriate plug-in receptacle 212, 305 and a plug-in 230, 310 for connecting to data source 120, a developer may quickly create an application definition 115 by connecting to and exploring a data source 120. The application definition 115 may be further modified before the application definition 115 is published to a repository and registry and afterwards provisioned to a device.

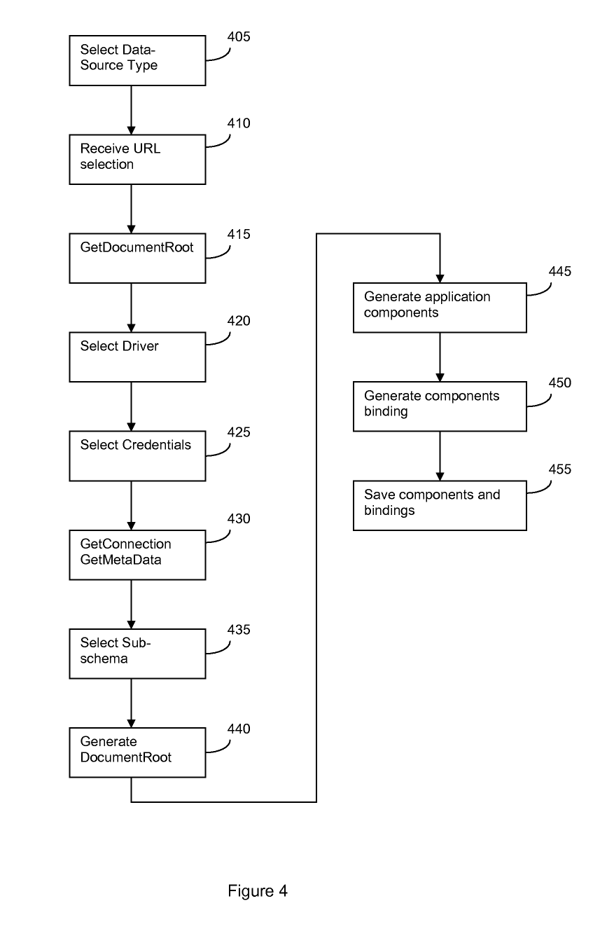

FIG. 4 shows in a flowchart an example of a method of using an IDE 200, 301 to create an application definition, in accordance with an embodiment of the present disclosure. The IDE 200, 301 provides a designer the ability to select the data source type, which determines the plug-in type to use (405). Once the designer's selection is received, a URL is received (410) for specifying the particular data source 120. The functionality of the plug-in 230, 310 is then called using the plug-in interface 306. In one embodiment, this is achieved by calling the getDocumentRoot (IConnectorInfo) method (415). The plug-in receives the IConnectorInfo specifying connection information for connecting to the data source 120. The plug-in 230, 310 sets an appropriate driver to be used when connecting to the data source 120 (420), and the connection credentials (425). The plug-in 230, 310 then connects to the data source 120 and explores the functionality exposed by the data source 120. In a particular embodiment this is done by calling getConnection and getMetaData (430). Once the meta-data is received, the plug-in 230, 310 may receive a selection of the desired exposed functionality to include in the description (435). The plug-in 230, 310 next generates the DocumentRoot (440) and returns it to the IDE 200, 301 using the plug-in interface 306. Using the Document Root, expressed in for example enhanced WSDL, the IDE 200, 301 generates the application definitions necessary for implementing the data source description (445). The IDE 200, 301 may also generate the bindings necessary for connecting the application components to the data source 120 (450). The IDE 200, 301 may finally save the application components and bindings (455).

The systems and methods according to the present invention may be implemented by any hardware, software or a combination of hardware and software having the above described functions. The software code, either in its entirety or a part thereof, may be stored in a computer-readable memory. Further, a computer data signal representing the software code which may be embedded in a carrier wave may be transmitted via a communication network. Such a computer-readable memory and a computer data signal are also within the scope of the present patent disclosure, as well as the hardware, software and the combination thereof.

While particular embodiments of the present invention have been shown and described, changes and modifications may be made to such embodiments without departing from the true scope of the invention.

What is claimed is:

1. A plug-in for use with an authoring application for facilitating development of a wireless application, the wireless application for communication with a data source described by a generic schema, the plug-in comprising:
a plug-in interface for interfacing with the authoring application, the plug-in interface defined by the authoring program;
logic for determining the functionality exposed by the data source described by the generic schema; and
a service descriptor generator for generating a service descriptor of the data source, the generated service descriptor being described using a schema common to the authoring application.

2. The plug-in as claimed in claim 1, further comprising a selector for selecting a subset of the functionality exposed by the data source to be included in the generated service descriptor.

3. The plug-in as claimed in claim 1, wherein the plug-in interface for interfacing with the authoring application comprises a structure for passing specific data source information to the plug-in.

4. The plug-in as claimed in claim 1, wherein the logic for determining the functionality exposed by the data source comprises:
logic for connecting to the data source; and
logic for exploring the functionality exposed by the data source.

5. The plug-in as claimed in claim 1, wherein the schema common to the authoring application is based on WSDL.

6. The plug-in as claimed in claim 3, wherein the plug-in interface for interfacing with the authoring application further comprises a structure for calling the logic for determining the functionality exposed by the data source.

7. The plug-in as claimed in claim 6, wherein the structure for passing specific data source information to the plug-in is an IConnectorInfo structure and the data source information comprises:
a URL for the data source;
a username for connecting to the data source; and
a password for connecting to the data source.

8. The plug-in as claimed in claim 7, wherein the structure for calling the logic for determining the functionality exposed by the data source comprises a getDocumentRoot method of an IConnector structure.

9. The plug-in as claimed in claim 1, wherein the authoring application is selected form the group comprising:
an integrated design environment;
a rapid application development tool; and
a text editor.

10. The plug-in as claimed in claim 1, wherein the wireless application is component application comprising:
at least one screen component defined in a structured definition language;
at least one data component defined in a structured definition language; and
at least one message component defined in a structured definition language.

11. A method for using a plug-in with an authoring application for facilitating development of a wireless application, the wireless application for communication with a data source described by a generic schema, the method comprising the steps of:
providing a plug-in interface for interfacing with the authoring application, the plug-in interface defined by the authoring program;
determining the functionality exposed by the data source described by the generic schema; and
generating a service descriptor of the data source, the generated service descriptor being described using a schema common to the authoring application.

12. The method as claimed in claim 11, further comprising the step of selecting a subset of the functionality exposed by the data source to be included in the generated service descriptor.

13. The method as claimed in claim 11, wherein the step of providing the plug-in interface for interfacing with the authoring application comprises the step of providing a structure for passing specific data source information to the plug-in.

14. The method as claimed in claim 11, wherein the step of determining the functionality exposed by the data source comprises:
connecting to the data source; and
exploring the functionality exposed by the data source.

15. The method as claimed in claim 11, wherein the schema common to the authoring application is based on WSDL.

16. The method as claimed in claim 13, wherein the step of providing the plug-in interface for interfacing with the authoring application further comprises the step of providing a structure for calling the logic for determining the functionality exposed by the data source.

17. The method as claimed in claim 16, wherein the structure for passing specific data source information to the plug-in is an IConnectorInfo structure and the data source information comprises:
a URL for the data source;
a username for connecting to the data source; and
a password for connecting to the data source.

18. The method as claimed in claim 17, wherein the structure for calling the logic for determining the functionality exposed by the data source comprises a getDocumentRoot method of an IConnector structure.

19. The method as claimed in claim 11, wherein the authoring application is selected form the group comprising:
an integrated design environment;
a rapid application development tool; and
a text editor.

20. The method as claimed in claim 11, wherein the wireless application is component application comprising:
at least one screen component defined in a structured definition language;
at least one data component defined in a structured definition language; and
at least one message component defined in a structured definition language.

21. A computer-readable medium storing instructions or statements for use in the execution in a computer of a method of using a plug-in with an authoring application for facilitating development of a wireless application, the wireless application for communication with a data source described by a generic schema, the method comprising the steps of:
providing a plug-in interface for interfacing with the authoring application, the plug-in interface defined by the authoring program;
determining the functionality exposed by the data source described by the generic schema; and
generating a service descriptor of the data source, the generated service descriptor being described using a schema common to the authoring application.
